(19) United States
(12) Patent Application Publication
(10) Pub. No.: US 2017/0116900 A1
(43) Pub. Date: Apr. 27, 2017

(54) HIGH DENSITY PIXEL PATTERN

(71) Applicant: Ignis Innovation Inc., Waterloo (CA)

(72) Inventor: Gholamreza Chaji, Waterloo (CA)

(21) Appl. No.: 15/333,734

(22) Filed: Oct. 25, 2016

(30) Foreign Application Priority Data
Oct. 26, 2015 (CA) 2909813

(51) Int. Cl. G09G 3/20; G09G 3/3233

(52) U.S. Cl. CPC G09G 3/2003; G09G 3/3233; G09G 2300/0452; G09G 2340/0407

(57) ABSTRACT

A pixel pattern of material light emissive areas for an emissive display system having pixels, each pixel having subpixels, each subpixel having a light emitting device defining the material light emissive area of the subpixel, the pixel pattern comprising: for each pixel, a shared elongated subpixel of a first primary color shared with an adjacent pixel and an elongated subpixel of a second or third primary color located in an area on an opposite side of the shared elongated subpixel from the adjacent pixel.

### PRIORITY CLAIM

This application claims priority to Canadian Application No. 2,909,813, filed Oct. 26, 2015, which is hereby incorporated by reference herein in its entirety.

### FIELD OF THE INVENTION

The present disclosure relates to pixel patterns for light emissive visual display technology, and particularly to pixel patterns for high pixel per inch (PPI) display in an active matrix light emitting diode device (AMOLED) and other emissive displays.

### BRIEF SUMMARY

According to one aspect, there is provided a pixel pattern of material light emissive areas for an emissive display system having pixels, each pixel having subpixels, each subpixel having a light emitting device defining the material light emissive area of the subpixel, the pixel pattern comprising: for each pixel, a shared elongated subpixel of a first primary color shared with an adjacent pixel and an elongated subpixel of a second or third primary color located in an area on an opposite side of the shared elongated subpixel from the adjacent pixel.

In some embodiments, the shared elongated subpixel has a length greater than half of a length or width of a pixel. In some embodiments, the shared elongated subpixel has a length extending substantially to the length or width of the pixel.

In some embodiments, the pixel pattern further comprises, for each pixel, at least one further subpixel of a the third or second primary color different from the second or third primary color of the elongated subpixel.

In some embodiments, the first primary color has less of an effect on perceived resolution than the second primary color. In some embodiments, the first primary color is blue.

In some embodiments, the shared elongated subpixel is driven with data for the first primary color associated with a first color for display by the pixel and data for the first primary color associated with a second color for display by the adjacent pixel. In some embodiments, the shared elongated subpixel is driven by a first subpixel circuit associated with the pixel with data for the first primary color associated with a first color for display by the pixel and is driven by a second subpixel circuit associated with the adjacent pixel with data for the first primary color associated with a second color for display by the adjacent pixel.

According to another aspect there is provided a pixel pattern of material light emissive areas for an emissive display system having pixels, each pixel having subpixels, each subpixel having a light emitting device defining the material light emissive area of the subpixel, the pixels of the pixel pattern arranged into pixel pairs, the pixel pattern comprising: for each pixel pair, a first pixel, and a second pixel adjacent the first pixel, each first pixel comprising a shared elongated subpixel of a first primary color shared with the second pixel, and an elongated subpixel of a second or third primary color located in an area on an opposite side of the shared elongated subpixel from the second pixel, and each second pixel comprising the shared elongated subpixel shared with the first pixel, and an elongated subpixel of a third or second primary color different from the second or third primary color of the elongated subpixel of the first pixel located in an area on an opposite side of the shared elongated subpixel from the first pixel.

In some embodiments, the pixel pairs are arranged in rows and columns, and adjacent columns or rows of pixel pairs possess alternating arrangement of second and third primary colors among the subpixels of the pixels. In some embodiments, adjacent pixels possess alternating arrangement of second and third primary colors among the subpixels of the pixels.

In some embodiments, the shared elongated subpixel of each pixel pair has a length greater than half of a length or width of a pixel. In some embodiments, the shared elongated subpixel of each pixel pair has a length extending substantially to the length or width of the pixel.

In some embodiments, the pixel pattern further comprises, for each pixel of each pixel pair, at least one further subpixel of a the third or second primary color different from the second or third primary color of the elongated subpixel of the pixel.

In some embodiments, the first primary color has less of an effect on perceived resolution than the second and third primary colors.

In some embodiments, the shared elongated subpixel of each pixel pair is driven with data for the first primary color associated with a first color for display by the first pixel and data for the first primary color associated with a second color for display by second pixel. In some embodiments, the shared elongated subpixel of each pixel pair is driven by a first subpixel circuit associated with the first pixel with data for the first primary color associated with a first color for display by the first pixel and is driven by a second subpixel circuit associated with the second pixel with data for the first primary color associated with a second color for display by the second pixel.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1A illustrates a known pixel pattern with one elongated subpixel per pixel;

FIG. 1B illustrates a known pixel pattern with elongated subpixels and in which each pixel shares two subpixels with adjacent pixels;

FIG. 2 illustrates an example display system in which pixels of the disclosed pixel and subpixel patterns are utilized;

FIG. 3 illustrates a pixel pattern in which each pixel shares one elongated subpixel with an adjacent pixel; and

FIG. 4 illustrates a pixel pattern in which each pixel shares one elongated subpixel with an adjacent pixel and for which neighboring pixels have alternating subpixel color patterns.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

Pixel and subpixel patterns are important for today's high density visual display technologies. Performance metrics of such displays include pixels per inch (PPI) which specifies how many picture elements or pixels there are per inch of the display, and aperture ratio (also known as fill factor) which is the ratio of the material area capable of producing light for a given portion of the display to the total area of that portion of the display. As such, higher PPI and greater aperture ratios are desirable in any display and particularly for high density displays.

Pixel and subpixel patterns are created using a fabrication process, and like all fabrication processes pixel patterning has its own physical limitations. Generally speaking, color patterning for emissive devices is achieved through masking. Design rules of the masking process, however, impose constraints upon spacing between each pixel and subpixel pattern as well as the width or size of each pixel or subpixel pattern. The limitations due to the fabrication process are relatively coarse in the limit of modern high density visual displays, preventing increases in PPI and imposing small fill factors.

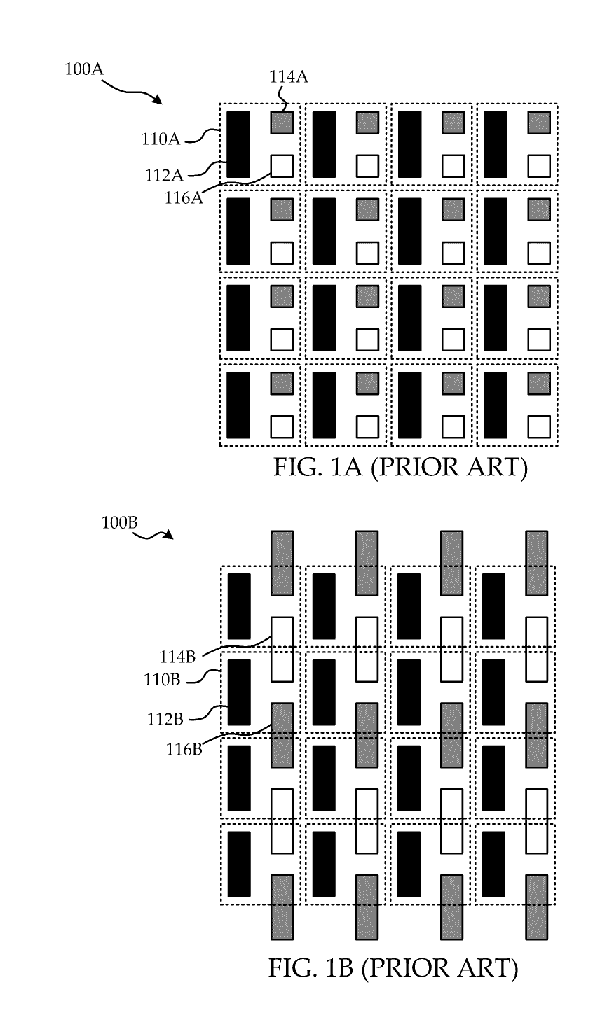

Referring to FIG. 1A and FIG. 1B, known pixel patterns 100A, 100B attempt to obtain higher PPI and greater fill factors but have drawbacks. The pixel pattern 100A of FIG. 1A includes an array of pixels arranged in rows and columns. Each pixel 110A comprises three subpixels which define the light emitting material areas of the pixel and include, an elongated subpixel 112A of a first primary color, a second subpixel 114A of a second primary color, and a third subpixel 116A of a third primary color. All of the pixels 100A are substantially similar to each other throughout the display. The elongated subpixel 112A has a width corresponding generally to the size of the other subpixels 114A, 116A, but is longer in one dimension, having a length extending along most of the length of a pixel 110A. This pixel pattern 100A, however, is not efficient at a very high PPI. The pixel pattern 100B of FIG. 1B also includes an array of pixels arranged in rows and columns. Each pixel 110B comprises three subpixels, a first elongated subpixel 112B of a first primary color, a second elongated subpixel 114B of a second primary color, and a third elongated subpixel 116B of a third primary color. All of the elongated subpixels 112B, 114B, 116B have similar widths and similar lengths. Each is longer in one dimension, having a length extending for a distance equal to most of the length of the pixel 110B. In this pixel pattern 100B, each pixel shares two elongated subpixels 114B 116B with adjacent pixels, an elongated subpixel 114B of one color (for example green) with one adjacent pixel and an elongated subpixel 116B of a second color (for example red) with another adjacent pixel.

Each pixel has substantially the same number, shape and size of subpixels, i.e. the geometry of the various subpixels arranged in each pixel is the same for all pixels. Each column has the same primary color arrangement of subpixels as all other columns, but adjacent rows of pixels possess alternating arrangement of red and green subpixels. This pixel pattern 100B, however, due to each pixel sharing two subpixels with adjacent pixels, specifically red and green, exhibits too great a loss of resolution.

While the embodiments described herein will be in the context of high density AMOLED displays it should be understood that the pixel and subpixel patterns described herein are applicable to any other display comprising pixels each having a plurality of subpixels, which are normally limited by methods of fabrication similar to masking.

It should be understood that the embodiments described herein pertain to pixel and subpixel patterns and do not limit the display technology underlying their operation and the operation of the displays in which they are implemented. The pixel and subpixel patterns described herein are applicable to any number of various types and implementations of various visual display technologies

Patents which describe innovative technologies in relation to high resolution AMOLED displays include U.S. Pat. No. 8,552,636, U.S. Pat. No. 8,803,417, and U.S. Pat. No. 9,059,117, each entitled “High Resolution Pixel Architecture” and granted to Chaji et al.

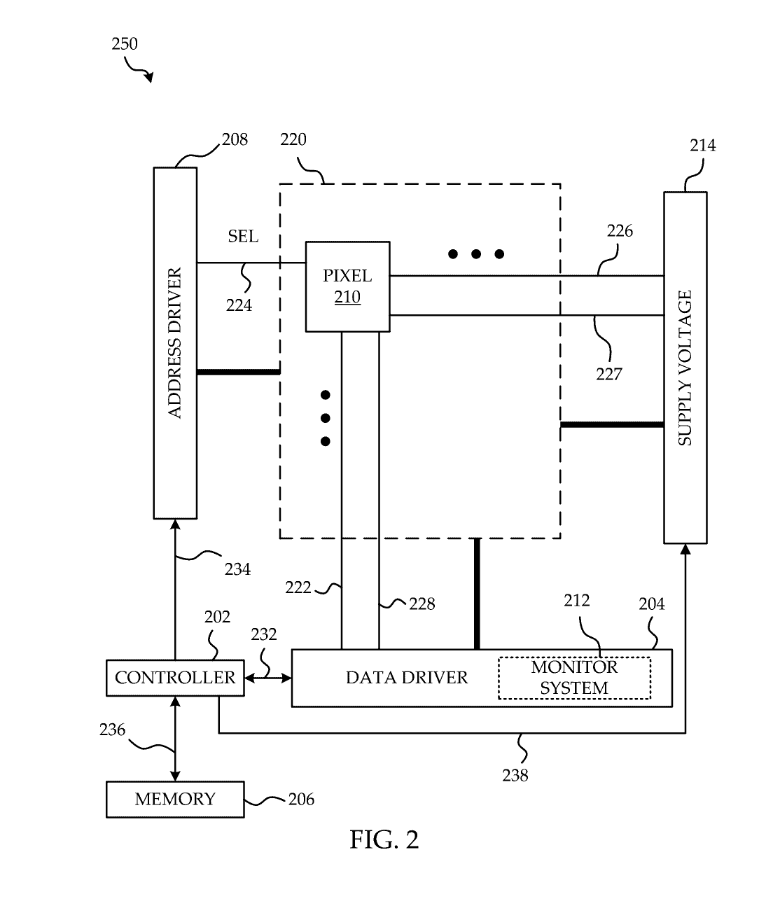

FIG. 2 is a diagram of an example display system 250 utilizing the pixel patterns described further below. The display system 250 includes a display panel 220, an address driver 208, a data driver 204, a controller 202, and a memory storage 206.

The display panel 220 includes an array of pixels 210 (only one explicitly shown) arranged in rows and columns. Each of the pixels 210 is individually programmable to emit light with individually programmable luminance values. The controller 202 receives digital data indicative of information to be displayed on the display panel 220. The controller 202 sends signals 232 to the data driver 204 and scheduling signals 234 to the address driver 208 to drive the pixels 210 in the display panel 220 to display the information indicated. The plurality of pixels 210 of the display panel 220 thus comprise a display array or display screen adapted to dynamically display information according to the input digital data received by the controller 202. The display screen can display images and streams of video information from data received by the controller 202. The supply voltage 214 provides a constant power voltage or can serve as an adjustable voltage supply that is controlled by signals from the controller 202. The display system 250 can also incorporate features from a current source or sink (not shown) to provide biasing currents to the pixels 210 in the display panel 220 to thereby decrease programming time for the pixels 210.

For illustrative purposes, only one pixel 210 is explicitly shown in the display system 250 in FIG. 2. It is understood that the display system 250 is implemented with a display screen that includes an array of a plurality of pixels, such as the pixel 210, and that the display screen is not limited to a particular number of rows and columns of pixels. For example, the display system 250 can be implemented with a display screen with a number of rows and columns of pixels commonly available in displays for mobile devices, monitor-based devices, and/or projection-devices. In a multichannel or color display, a number of different types of pixels, each responsible for reproducing color of a particular channel or color such as red, green, blue, or white will be present in the display. Pixels of this kind may also be referred to as “subpixels” as a group of them collectively provide a desired color at a particular row and column of the display, which group of subpixels may collectively also be referred to as a “pixel”.

The subpixels of the pixel 210 are operated by a driving circuit or pixel circuit that generally includes a driving transistor and a light emitting device. The light emitting device can optionally be an organic light emitting diode, having a shape and size defining the material area from which light of the subpixel is produced, but implementations of the present disclosure apply to pixel circuits having other electroluminescence devices, including current-driven light emitting devices and others. The driving transistor in the pixel 210 can optionally be an n-type or p-type amorphous silicon thin-film transistor, but implementations of the present disclosure are not limited to pixel circuits having a particular polarity of transistor or only to pixel circuits having thin-film transistors. The pixel circuit 210 can also include a storage capacitor for storing programming information and allowing the pixel circuit 210 to drive the light emitting device after being addressed. Thus, the display panel 220 can be an active matrix display array.

As illustrated in FIG. 2, the pixel 210 illustrated as the top-left pixel in the display panel 220 is coupled to a select lines 224, a supply line 226, a data lines 222, and a monitor line 228. A read line may also be included for controlling connections to the monitor line. In one implementation, the supply voltage 214 can also provide a second supply line to the pixel 210. For example, each pixel can be coupled to a first supply line 226 charged with Vdd and a second supply line 227 coupled with Vss, and the pixel circuits 210 can be situated between the first and second supply lines to facilitate driving current between the two supply lines during an emission phase of the pixel circuit. It is to be understood that each of the pixels 210 in the pixel array of the display 220 is coupled to appropriate select lines, supply lines, data lines, and monitor lines. It is noted that aspects of the present disclosure apply to pixels having additional connections, such as connections to additional select lines, and to pixels having fewer connections.

With reference to the pixel 210 of the display panel 220, the select lines 224 is provided by the address driver 208, and can be utilized to enable, for example, a programming operation of the pixel 210 by activating a switch or transistor to allow the data lines 222 to program the various subpixels of the pixel 210. The data lines 222 convey programming information from the data driver 204 to the pixel 210. For example, the data lines 222 can be utilized to apply programming voltages or programming current to the subpixels of the pixel 210 in order to program the subpixels of the pixel 210 to emit a desired amount of luminance. The programming voltages (or programming current) supplied by the data driver 204 via the data lines 222 are voltages (or currents) appropriate to cause the subpixels of the pixel 210 to emit light with a desired amount of luminance according to the digital data received by the controller 202. The programming voltages (or programming currents) can be applied to the subpixels of the pixel 210 during a programming operation of the pixel 210 so as to charge storage devices within the subpixels of the pixel 210, such as a storage capacitor, thereby enabling the subpixels of the pixel 210 to emit light with the desired amount of luminance during an emission operation following the programming operation. For example, the storage device in a subpixel of the pixel 210 can be charged during a programming operation to apply a voltage to one or more of a gate or a source terminal of the driving transistor during the emission operation, thereby causing the driving transistor to convey the driving current through the light emitting device according to the voltage stored on the storage device.

Generally, in each subpixel of the pixel 210, the driving current that is conveyed through the light emitting device by the driving transistor during the emission operation of the pixel 210 is a current that is supplied by the first supply line 226 and is drained to a second supply line 227. The first supply line 226 and the second supply line 227 are coupled to the voltage supply 214. The first supply line 226 can provide a positive supply voltage (e.g., the voltage commonly referred to in circuit design as “Vdd”) and the second supply line 227 can provide a negative supply voltage (e.g., the voltage commonly referred to in circuit design as “Vss”). Implementations of the present disclosure can be realized where one or the other of the supply lines (e.g., the supply line 227) is fixed at a ground voltage or at another reference voltage.

The display system 250 also includes a monitoring system 212. With reference again to the pixel 210 of the display panel 220, the monitor line 228 connects the pixel 210 to the monitoring system 212. The monitoring system 212 can be integrated with the data driver 204, or can be a separate stand-alone system. In particular, the monitoring system 212 can optionally be implemented by monitoring the current and/or voltage of the data line 222 during a monitoring operation of the pixel 210, and the separate monitor line 228 can be entirely omitted.

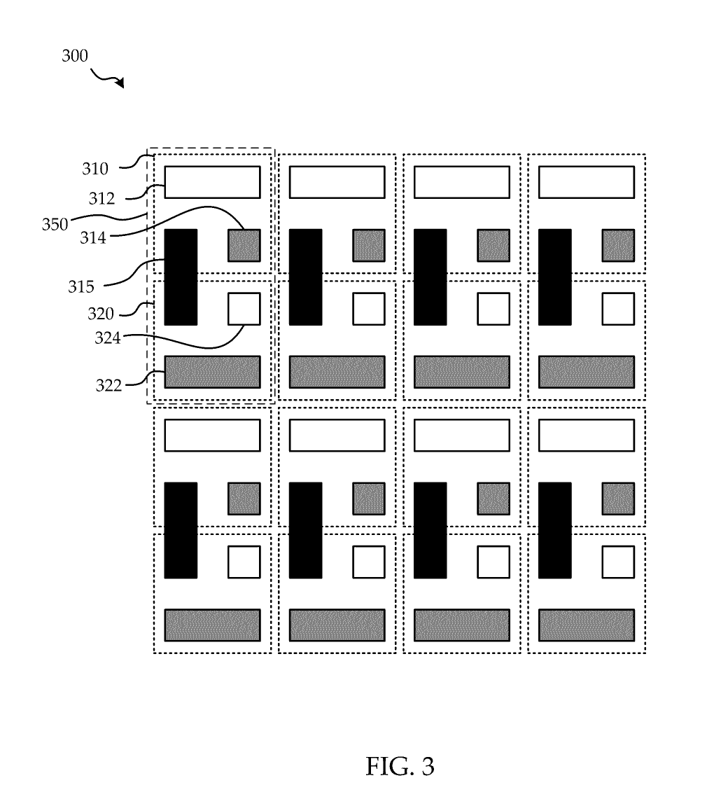

Referring to FIG. 3, a pixel pattern 300 according to an embodiment will now be described. The pixel pattern 300 includes an array of pixels arranged in rows and columns and grouped in pairs. Each pixel pair 350 comprises a first pixel 310 and a second pixel 320 adjacent to one another. Each first pixel 310 of each pixel pair 350 comprises three subpixels, a shared elongated subpixel 315 of a first primary color which is shared with the second pixel 320 of the pixel pair 350, an elongated subpixel 312 of a second primary color, and a further subpixel 314 of a third primary color. Each second pixel 320 of each pixel pair 350 comprises three subpixels, the shared elongated subpixel 315 which is shared with the first pixel 310 of the pixel pair 350, an elongated subpixel 322 of the third primary color, and a further subpixel 324 of the second primary color. All of the elongated subpixels 315, 312, 322 have similar widths and similar lengths. Each is longer in one dimension, having a length extending for a distance equal to most of the length (or width) of a pixel 310, 320 (greater than half) and possibly extending to a length substantially the same as the length (or width) of the pixel 310, 320. The shared elongated subpixel 315 of each pixel pair 350 is oriented perpendicularly to a line bisecting the pixel pair 350 between the first and second pixels 310, 320. The elongated subpixels 312 322 of the first and second pixels 310, 320 are oriented perpendicularly to the orientation of the shared elongated subpixel 315, and each is located within its respective pixel 310, 320 closer to the edge of that pixel which is farthest away from the adjacent, other pixel 320, 310 of the pixel pair 350. In this pixel pattern 300, each pixel 310, 320 shares only one shared elongated subpixel 315 with the other adjacent pixel 320, 310 of the pixel pair 350. The first pixel 310 and the second pixel 320 of the pixel pair 350 are, geometrically speaking, mirror images of each other in a line bisecting the pixel pair 350 between the first pixel 310 and the second pixel 320 of the pixel pair 350. Each pixel pair 350 has substantially the same number, shape and size of subpixels, i.e., the geometry of the various subpixels and pixels arranged in each pixel pair is the same for all pixel pairs, and each pixel pair has the same primary color arrangement of subpixels as all other pixel pairs.

For some embodiments, in each pixel pair 350 of the pixel pattern 300, the first primary color, or the primary color of the shared elongated subpixel 315 is blue which has relatively less of an effect on perceived resolution, and may be any other color which has relatively less of an effect on perceived resolution. In some embodiments, such a shared elongated subpixel 315 may be driven by one subpixel circuit or two separate subpixel circuits. In the case of a single subpixel circuit, data for the first primary color associated with the color for display by the first pixel 310 and data for the first primary color associated with the color for display by the second pixel 320 are both used to drive the brightness of the shared subpixel 315. In the case of two separate subpixel circuits driving the shared elongated subpixel 315, the data for the first primary color associated with the color for display by the first pixel 310 is utilized by a first subpixel circuit to drive the shared elongated subpixel 315 while data for the first primary color associated with the color for display by the second pixel 320 is utilized by a second subpixel circuit to drive the shared elongated subpixel 315. In the case of the shared elongated subpixel's 315 being driven by two separate subpixel circuits, the resolution loss is significantly minimized.

The pixel pattern 300, having greater pattern area per unit area of the display results in a higher fill factor, or aperture ratio than similarly sized (i.e., of similar PPI) patterns such as those illustrated in FIG. 1A and FIG. 1B. Differences between pixels in the size and shape of the pattern for each color, such as for example, the elongated subpixel 412 of the first pixel 450 is larger than the further subpixel 424 of the second subpixel 420 but has the same primary color, may cause some visual artifacts. Driving each pixel differently to account for these differences can be used to correct for these visual artifacts.

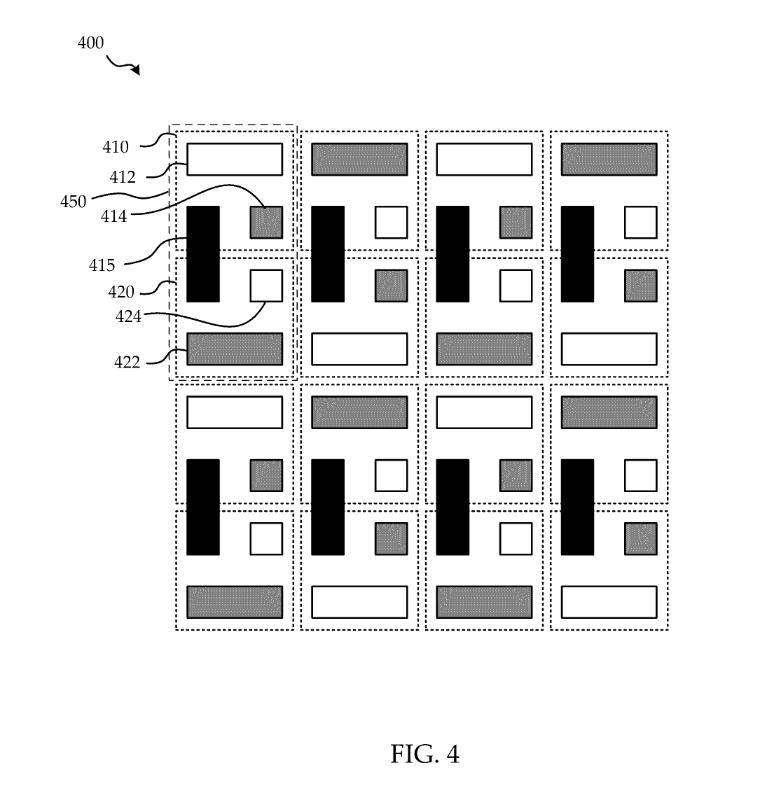

Referring to FIG. 4, a pixel pattern 400 according to an embodiment will now be described. This pixel pattern is less susceptible to the visual artifacts due to differences between pixels in the size and shape of the pattern for each color as described above. The pixel pattern 400 includes an array of pixels arranged in rows and columns and grouped in pairs. Each pixel pair 450 comprises a first pixel 410 and a second pixel 420 adjacent to one another. Each first pixel 410 of each pixel pair 450 comprises three subpixels, a shared elongated subpixel 415 of a first primary color which is shared with the second pixel 420 of the pixel pair 450, an elongated subpixel 412, and a further subpixel 414. Each second pixel 420 of each pixel pair 450 comprises three subpixels, the shared elongated subpixel 415 which is shared with the first pixel 410 of the pixel pair 450, an elongated subpixel 422, and a further subpixel 424. All of the elongated subpixels 415, 412, 422 have similar widths and similar lengths. Each is longer in one dimension, having a length extending for a distance equal to most of the length (or width) of a pixel 410, 420 (greater than half) and possibly extending to a length substantially the same as the length (or width) of the pixel 410, 420. The shared elongated subpixel 415 of each pixel pair 450 is oriented perpendicularly to a line bisecting the pixel pair 450 between the first and second pixels 410, 420. The elongated subpixels 412 422 of the first and second pixels 410, 420 are oriented perpendicularly to the orientation of the shared elongated subpixel 415, and each is located within its respective pixel 410, 420 closer to the edge of that pixel which is farthest away from the adjacent, other pixel 420, 410 of the pixel pair 450. In this pixel pattern 400, each pixel 410, 420 shares only one shared elongated subpixel 415 with the other adjacent pixel 420, 410 of the pixel pair 450. The first pixel 410 and the second pixel 420 of the pixel pair 450 are, geometrically speaking, mirror images of each other in the line bisecting the pixel pair 450 between the first pixel 410 and the second pixel 420 of the pixel pair 450.

In each pixel pair 450, the elongated subpixel 412 of the first pixel 410 and the further subpixel 424 of the second pixel 420 are the same color which is one of the second and the third primary color, while the elongated subpixel 422 of the second pixel 420 and the further subpixel 414 of the first pixel 410 are the same color which is the other of the second and the third primary color.

Each pixel pair 450 has substantially the same number, shape and size of subpixels, i.e. the geometry of the various subpixels and pixels arranged in each pixel pair is the same for all pixel pairs. Each row of pixel pairs have the same primary color arrangement of subpixels and pixels as all other rows of pixel pairs, but adjacent columns of pixel pairs possess alternating arrangement of second and third primary colors among the subpixels. Equivalently, adjacent pixels possess alternating arrangement of second and third primary colors among the subpixels. The alternation of the second and third primary colors in adjacent columns of pixel pairs reduces visual artifacts due to the differences in shape and size of the pattern for each color as described above.

For some embodiments, in each pixel pair 450 of the pixel pattern 400, the first primary color, or the primary color of the shared elongated subpixel 415 is blue which has relatively less of an effect on perceived resolution, and may be any other color which has relatively less of an effect on perceived resolution. In some embodiments, such a shared elongated subpixel 415 may be driven by one subpixel circuit or two separate subpixel circuits. In the case of a single subpixel circuit, data for the first primary color associated with the color for display by the first pixel 410 and data for the first primary color associated with the color for display by the second pixel 420 are both used to drive the brightness of the shared subpixel 415. In the case of two separate subpixel circuits driving the shared elongated subpixel 415, the data for the first primary color associated with the color for display by the first pixel 410 is utilized by a first subpixel circuit to drive the shared elongated subpixel 415 while data for the first primary color associated with the color for display by the second pixel 420 is utilized by a second subpixel circuit to drive the shared elongated subpixel 415. In the case of the shared elongated subpixel's 415 being driven by two separate subpixel circuits, the resolution loss is significantly minimized.

The pixel pattern 400, having greater pattern area per unit area of the display results in a higher fill factor, or aperture ratio than similarly sized (i.e., of similar PPI) patterns such as those illustrated in FIG. 1A and FIG. 1B.

It should be understood that although the above makes reference to pixels and pixel pairs of the pixel patterns being arranged in “rows” and “columns”, these terms are interchangeable with regard to the orientation and configuration of each of the repeating patterns described above. Although the above makes reference to a pixel's “width” and “length” it is understood that these terms are interchangeable.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A pixel pattern of material light emissive areas for an emissive display system having pixels, each pixel having subpixels, each subpixel having a light emitting device defining the material light emissive area of the subpixel, the pixel pattern comprising:
for each pixel, a shared elongated subpixel of a first primary color shared with an adjacent pixel and an elongated subpixel of a second or third primary color located in an area on an opposite side of the shared elongated subpixel from the adjacent pixel.

2. The pixel pattern of claim 1, wherein the shared elongated subpixel has a length greater than half of a length or width of a pixel.

3. The pixel pattern of claim 2, wherein the shared elongated subpixel has a length extending substantially to the length or width of the pixel.

4. The pixel pattern of claim 1, wherein the pixel pattern further comprises, for each pixel, at least one further subpixel of a the third or second primary color different from the second or third primary color of the elongated subpixel.

5. The pixel pattern of claim 1, wherein the first primary color has less of an effect on perceived resolution than the second primary color.

6. The pixel pattern of claim 5, wherein the first primary color is blue.

7. The pixel pattern of claim 1, wherein the shared elongated subpixel is driven with data for the first primary color associated with a first color for display by the pixel and data for the first primary color associated with a second color for display by the adjacent pixel.

8. The pixel pattern of claim 7, wherein the shared elongated subpixel is driven by a first subpixel circuit associated with the pixel with data for the first primary color associated with a first color for display by the pixel and is driven by a second subpixel circuit associated with the adjacent pixel with data for the first primary color associated with a second color for display by the adjacent pixel.

9. A pixel pattern of material light emissive areas for an emissive display system having pixels, each pixel having subpixels, each subpixel having a light emitting device defining the material light emissive area of the subpixel, the pixels of the pixel pattern arranged into pixel pairs, the pixel pattern comprising:
for each pixel pair, a first pixel, and a second pixel adjacent the first pixel,
each first pixel comprising a shared elongated subpixel of a first primary color shared with the second pixel, and an elongated subpixel of a second or third primary color located in an area on an opposite side of the shared elongated subpixel from the second pixel, and
each second pixel comprising the shared elongated subpixel shared with the first pixel, and an elongated subpixel of a third or second primary color different from the second or third primary color of the elongated subpixel of the first pixel located in an area on an opposite side of the shared elongated subpixel from the first pixel.

10. The pixel pattern of claim 9, wherein the pixel pairs are arranged in rows and columns, and adjacent columns or rows of pixel pairs possess alternating arrangement of second and third primary colors among the subpixels of the pixels.

11. The pixel pattern of claim 9, wherein adjacent pixels possess alternating arrangement of second and third primary colors among the subpixels of the pixels.

12. The pixel pattern of claim 9, wherein the shared elongated subpixel of each pixel pair has a length greater than half of a length or width of a pixel.

13. The pixel pattern of claim 12, wherein the shared elongated subpixel of each pixel pair has a length extending substantially to the length or width of the pixel.

14. The pixel pattern of claim 9, wherein the pixel pattern further comprises, for each pixel of each pixel pair, at least one further subpixel of a the third or second primary color different from the second or third primary color of the elongated subpixel of the pixel.

15. The pixel pattern of claim 9, wherein the first primary color has less of an effect on perceived resolution than the second and third primary colors.

16. The pixel pattern of claim 15, wherein the first primary color is blue.

17. The pixel pattern of claim 9, wherein the shared elongated subpixel of each pixel pair is driven with data for the first primary color associated with a first color for display by the first pixel and data for the first primary color associated with a second color for display by second pixel.

18. The pixel pattern of claim 17, wherein the shared elongated subpixel of each pixel pair is driven by a first subpixel circuit associated with the first pixel with data for the first primary color associated with a first color for display by the first pixel and is driven by a second subpixel circuit associated with the second pixel with data for the first primary color associated with a second color for display by the second pixel.
